(19) United States
(12) Patent Application Publication
(10) Pub. No.: US 2011/0282003 A1
(43) Pub. Date: Nov. 17, 2011

(54) Free-radical Stable Polymers that are Curable in the Presence of Co-agent

(76) Inventors: J. Scott Parent, Kingston (CA); Ralph A. Whitney, Kingston (CA); Karthik Vikram Siva Shanmugam, Kingston (CA)

(21) Appl. No.: 13/108,059

(22) Filed: May 16, 2011

Related U.S. Application Data
(60) Provisional application No. 61/345,396, filed on May 17, 2010.

(51) Int. Cl. C08F 136/08; C08F 8/00; C08F 236/10

(52) U.S. Cl. 525/55; 526/340.2; 526/340; 526/262; 526/320; 526/324

(57) ABSTRACT

A polymer is described that is stable in the presence of a free-radical initiator, but which cures when subjected to a small amount of free-radical initiator when in the presence of a co-agent. The polymer's main chain comprises polymerized olefin monomers, isobutylene-co-isoprene, or isobutylene-co-methylstyrene. The polymer's side chains comprise a functionality that crosslinks when subjected to a free-radical initiator in the presence of a co-agent. Suitable co-agents include bis-maleimide. Methods for preparing and for crosslinking such polymers are described. Cured product is halo-free and has low odour.

### FIELD OF THE INVENTION

The present invention relates to polymer compositions that can be cross-linked to form cured products using standard free-radical-initiated curing techniques.

### BACKGROUND OF THE INVENTION

Poly(isobutylene-co-isoprene), or IIR, is a synthetic elastomer commonly known as butyl rubber that has been prepared since the 1940's through random cationic copolymerization of isobutylene with small amounts of isoprene (1-2 mole %). As a result of its molecular structure, IIR possesses superior gas impermeability, excellent thermal stability, good resistance to ozone oxidation, exceptional dampening characteristics, and extended fatigue resistance.

In many of its applications butyl rubber is cross-linked to generate thermoset articles with greatly improved modulus, creep resistance and tensile properties. Alternate terms for crosslinked include vulcanized and cured. Crosslinking systems that are typically utilized for IIR include sulfur, quinoids, resins, sulfur donors and low-sulfur, high-performance vulcanization accelerators. IIR can be halogenated to introduce allylic halide functionality that is reactive toward sulfur nucleophiles and toward Lewis acids such as organozinc complexes. As a result, materials such as brominated butyl rubber, or BIIR, crosslink more rapidly than IIR when treated with standard vulcanization formulations.

Free-radical initiated curing techniques are valued when it is desirable to obtain cured articles that are substantially free of byproducts that include sulfur and/or metals. Although many commercially available elastomers are readily cured by currently available peroxide-initiated crosslinking techniques, poly(isobutylene-co-isoprene) is not (Loan, L. D. Pure Appl. Chem. 1972, 30, 173-180; Loan, L. D. Rubber Chem. Technol. 1967, 40, 149-176). Instead, under the action of organic peroxides, IIR suffers molecular weight losses by macro-radical fragmentation that are greater than any molecular weight gains obtained through macro-radical combination (Loan, L. D. J. Polym. Sci. Part A: Polym. Chem. 1964, 2, 2127-2134; Thomas, D. K. Trans. Faraday Soc. 1961, 57, 511-517).

In addition to failing to cure by peroxide-initiated crosslinking techniques, IIR also fails to cure appreciably under standard co-agent-based cure formulations, as evidenced by low yields observed for poly(isobutylene) grafting to acrylate, styrenic, and maleimide functionality (Kato, M. et al. J. Polym. Sci. Part A: Polym. Chem. 2006, 44, 1182-1188; Abbate, M. et al. J. Appl. Polym. Sci. 1995, 58, 1825-1837). HR grades with isoprene content in excess of 4 mol % have been developed, that cure when mixed with significant quantities of peroxide (1 to 5 wt %) and co-agents such as N,N′-m-phenylenedimaleimide (2.5 wt %) (Asbroeck, E. V. et al., Canadian Patent No. 2,557,217 (2005). These high initiator and co-agent loadings resulted in expensive cure formulations, and vulcanizates that contained high levels of initiator-derived byproducts such as ketones and alcohols.

Oxely and Wilson used a cationic copolymerization of isobutylene and divinylbenzene to prepare an isobutylene-rich elastomer that responded positively to peroxide-initiated cross-linking (Oxely, C. E.; Wilson, G. J. Rubber Chem. Technol. 1969, 42, 1147-1154). However, the activation of both vinyl groups during the polymerization process yielded a product that contained a very high gel content, which impacted negatively on the material's processing characteristics.

Therefore, there exists a need for a halogen-free and metal-free isobutylene-rich polymer that cures efficiently with a co-agent without need for excessive free-radical initiation, and for articles made therefrom.

### SUMMARY OF THE INVENTION

In a first aspect, the invention provides a polymer comprising: a polymeric main chain that comprises polymerized olefin monomers, isobutylene-co-isoprene, or isobutylene-co-methylstyrene; and a plurality of side chains comprising a co-curing functionality which is an ether, a terminal olefin, or an internal olefin; wherein the polymer forms crosslinks when subjected to a free-radical initiator only in the presence of a co-agent.

In a second aspect, the invention provides a method of making a polymer of the first aspect comprising: reacting halogenated polymer with a nucleophile that comprises a co-curing functionality, wherein the nucleophile replaces the halide of the halogenated polymer. In an embodiment of the second aspect, the nucleophile that comprises a co-curing functionality further comprises a carboxylate group. In an embodiment of the second aspect, the halogenated polymer is BIIR, CIIR, BIMS, or polychloroprene.

In a third aspect, the invention provides a crosslinked polymer prepared by subjecting the polymer of the first aspect to a free-radical initiator in the presence of a co-agent.

In a fourth aspect, the invention provides an inner liner composition comprising the crosslinked polymer of the third aspect.

In a fifth aspect, the invention provides a method of crosslinking a polymer of the first aspect, comprising: mixing the polymer with a co-agent to form a mixture; subjecting the mixture to a free-radical initiator; and allowing reactions to occur such that crosslinking-bonds form and cured product is obtained.

In a sixth aspect, the invention provides a kit comprising: the polymer of the first aspect; co-agent; optionally, a free-radical initiator; and instructions for use of the kit comprising directions to subject a mixture of the polymer and the co-agent to free-radical initiation to form a cross-linked polymer. In an embodiment of the sixth aspect, the instructions comprise printed material, text or symbols provided on an electronic-readable medium, directions to an internet web site, or electronic mail.

In embodiments of all of the above aspects, the co-agent comprises at least two maleimide moieties.

In embodiments of all of the above aspects, the co-agent is maleimide, bis-maleimide, tris-maleimide, trimethylolpropane triacrylate, diallylisophthalate, N,N′-m-phenylenedimaleimide, N,N′-hexamethylenedimaleimide, or a combination thereof.

In embodiments of all of the above aspects, the free-radical initiator is: a chemical free-radical initiator, a photoinitiator, heat, heat in the presence of oxygen, electron bombardment, irradiation, high-shear mixing, photolysis (photo-initiation), electron beam radiation, or radiation bombardment. In certain embodiments, the chemical free-radical initiator is an organic peroxide, a hydroperoxide, bicumene, dicumyl peroxide, di-t-butyl peroxide, an azo-based initiator, or homolysis of an organic peroxide.

Embodiments of all of the above aspects further comprise one or more filler.

### BRIEF DESCRIPTION OF THE DRAWINGS

For a better understanding of the invention and to show more clearly how it may be carried into effect, reference will now be made by way of example to the accompanying drawings, which illustrate aspects and features according to embodiments of the present invention, and in which:

FIG. 1 is a graph illustrating the evolution of storage modulus (G′) for DCP-initiated cures of polyisobutylene and polyisobutylene+2 wt % HVA2 (160° C.; 0.5 wt % DCP).

FIG. 2 is a graph illustrating the evolution of storage modulus (G′) for DCP-initiated cures of IIR-g-ether and IIR-g-ether+2 wt % HVA2 (160° C.; 0.5 wt % DCP).

FIG. 3 is a graph illustrating the evolution of storage modulus (G′) for DCP-initiated cures of IIR-g-PEG and IIR-g-PEG+2 wt % HVA2 (160° C.; 0.5 wt % DCP).

FIG. 4 is a graph illustrating the evolution of storage modulus (G′) for DCP-initiated cures of IIR-g-decenol and IIR-g-decenol+2 wt % HVA2 (160° C.; 0.5 wt % DCP).

FIG. 5 is a graph illustrating the evolution of storage modulus (G′) for DCP-initiated cures of IIR-g-farnesol and IIR-g-farnesol+2 wt % HVA2 (160° C.; 0.5 wt % DCP).

FIG. 6 is a graph illustrating the evolution of storage modulus (G′) for DCP-initiated cures of IIR-g-oleate and IIR-g-oleate+2 wt % HVA2 (160° C.; 0.1 wt % DCP).

FIG. 7 is a graph illustrating the evolution of storage modulus (G′) for DCP-initiated cures of IIR-g-lineolate and IIR-g-lineolate+2 wt % HVA2 (160° C.; 0.1 wt % DCP).

FIG. 8 is a graph illustrating the evolution of storage modulus (G′) for DCP-initiated cures of IIR-g-undecenoate and IIR-g-undecenoate+2 wt % HVA2 (160° C.; 0.1 wt % DCP).

### DETAILED DESCRIPTION OF THE INVENTION

The present invention includes polymers that are stable under free-radical initiating conditions that can be cross-linked by small amounts of free-radical initiator only when combined with a co-agent. Processes for making and for curing such polymers, and the cured articles derived therefrom are also described. The following terms will be used in this description.

### Definitions

As used herein, “aliphatic” is intended to encompass saturated or unsaturated hydrocarbon moieties that are straight chain, branched or cyclic and, further, the aliphatic moiety may be substituted or unsubstituted.

As used herein, the terms “curing”, “vulcanizing”, or “cross-linking” refer to the formation of covalent bonds that link one polymer chain to another, thereby altering the physical properties of the material.

As used herein, the term “co-curing” refers to curing only in the presence of a co-agent.

As used herein, the term “radical generating technique” means a method of creating free radicals, including the use of chemical initiators, photo-initiation, radiation bombardment, thermo-mechanical processes, oxidation reactions or other techniques known to those skilled in the art.

As used herein, the term “co-agent” refers to a compound containing two or more C═C bonds that engage in free radical addition reactions.

As used herein, the term “pendant functionality” means a functional group that is attached to the backbone of a polymer chain.

As used herein, the term “co-curing functionality” means pendant functionality that reacts with a co-agent when subjected to a radical generating technique.

As used herein, the term “co-curing polymer” means a polymer that contains co-curing functionality.

As used herein, the term “IIR” means a random copolymer of isobutylene and less than 4 mole % isoprene, which is a synthetic elastomer commonly known as butyl rubber. As used herein, the term “BIIR” means brominated butyl rubber, and the term “CIIR” means chlorinated butyl rubber.

As used herein, the term “BIMS” means brominated poly(isobutylene-co-methylstyrene).

As used herein, the term “nucleophilic substitution” refers to a class of substitution reaction in which an electron-rich nucleophile bonds with or attacks a positive or partially positive charge of an atom attached to a leaving group. In certain examples herein, nucleophilic substitution refers to displacement of a halide from BIIR by a nucleophilic reagent and includes esterification.

### DESCRIPTION

As discussed above, using previously known technology, it was not possible to cure isobutylene-rich elastomers efficiently by free-radical addition to co-agents. Although mixtures of bis-maleimide co-agents and BIIR do cure when activated by a free-radical generating technique to yield a vulcanized material, the product of that process contains residual halogen, which is undesirable for many electrical and pharmaceutical applications. By contrast, the present invention provides halogen-free cured product.

Surprisingly, it has been discovered that introducing co-curing functionality (defined above) to an isobutylene-rich polymer backbone gives a co-curing polymer (also defined above) that does not cross-link when exposed to small doses of a free-radical initiator in the absence of a co-agent, but that efficiently cross-links when exposed to small doses of a free-radical initiator in the presence of a co-agent.

Co-curing polymers do not cure efficiently under the action of radical initiators alone, nor do they suffer from thermo-oxidative cross-linking during prolonged storage. However, co-curing polymers become highly reactive when mixed with a co-agent, thereby providing a formulation that cures extensively when exposed to only small doses of radical initiation. Since only small doses of radical initiator are required, curing co-curing polymers is cost efficient and resulting vulcanizates have low odour compared to vulcanizates resulting from other techniques.

Also advantageous, vulcanizates of co-curing polymers have low concentrations of initiator-derived and co-agent-derived byproducts. Moreover, the resulting cured article contains relatively small amounts of the unconverted functionality that can lead to chemical and physical property instability.

As described above, isobutylene-rich polymers do not cross-link when exposed to small doses of a radical generating technique. The introduction of co-curing functionality to a polymer backbone yields a co-curing polymer that is similarly unaffected by a radical generating technique. This is because co-curing functionality is not converted efficiently to higher molecular weight products under these reaction conditions. Surprisingly, when a co-curing polymer is mixed with a co-agent, the resulting formulation will cure extensively when activated using radical initiation methods. This is because co-curing functionality and a co-agent can engage in efficient free-radical addition reactions that generate covalent bonds between polymer chains.

One aspect of the present invention involves a polymer comprising a polymeric backbone and attached to the polymer backbone a plurality of pendant groups comprising co-curing functionality. As those with skill in the art of the invention will recognize, many pendant groups are attached to a polymeric backbone; for convenience herein, a single representative pendant group is described.

### Co-Curing Functionality

Since a co-curing polymer is cross-linked through reactions between a co-curing functionality and a co-agent, the number of co-curing functional groups per polymer chain will affect the extent of polymer cross-linking that can be achieved. Typically, the average co-curing functionality content is from about 0.1 to about 100 pendant groups per 1000 polymer backbone carbons. In some embodiments, the average functional group content is between about 5 and about 50 pendant groups per 1000 polymer backbone carbons. It will be understood by those skilled in the art that reference to average co-curing functionality content refers to a population of polymer molecules and not necessarily to a single or particular polymer molecule.

In an embodiment, the co-curing functionality is an ether,

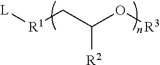

where R¹ is selected from C₁₋₁₂ aliphatic group, an aryl group, or a combination thereof, R² and R³ are hydrogen, a C₁₋₁₂ aliphatic group, an aryl group, or a combination thereof, and L is the covalent link to the polymer backbone as described below. In some embodiments, an aliphatic group is alkyl. The variable n can range from 1 to about 100. In certain embodiments, n is from 2 to about 20. Non-limiting examples of co-curing functionalities that comprise an ether group include L-(CH₂—CH₂—O)₂-Me, and L-(CH₂—CHMe-O)₁₈-Et.

The covalent link (“L”) between the polymer backbone and co-curing functionality is not particularly restricted, and the selection of “L” is within the purview of a person skilled in the art. A suitable covalent attachment is inert when exposed to a radical generating technique. Non-limiting examples of a covalent link between polymer backbone and co-curing functionality include an ester, ether, amide, and thioether. An ester covalent link is illustrated below:

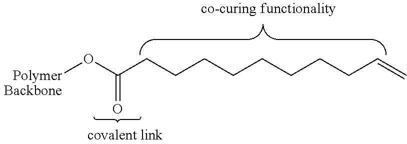

In another embodiment, the co-curing functionality is a terminal olefin,

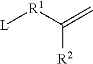

where R¹ is a C₁₋₁₂ aliphatic group, R² is hydrogen, or a C₁₋₁₂ aliphatic group, and L is as defined above. In some embodiments, aliphatic is alkyl. Non-limiting examples of co-curing functionalities that comprise a terminal olefin include

L-(CH₂)₁₀CH═CH₂ and L-(CH₂)₈CMe=CH₂.

In another embodiment, the co-curing functionality is an internal olefin,

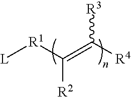

where R¹ is a C₁₋₁₂ aliphatic group; R², R³ and R⁴ are hydrogen or a C₁₋₁₂ aliphatic group, and L is as defined above. In some embodiments, aliphatic is alkyl. Any combination of R², R³ and R⁴ may form a cyclic moiety. The C═C bond may be a cis-isomer, a trans-isomer, or mixtures thereof, and may form part of a cyclic compound. The variable n can range from 1 to about 100. In some embodiments, n is from 1 to 20. Non-limiting examples of co-curing functionalities that comprise an internal olefin include: L-(CH₂)₇—CH═CH—(CH₂)₇CH₃; L-(CH₂)₇—CH═CH—(CH₂)—CH═CH—(CH₂)—CH₃; L-(CH₂—CH═CH—CH₂)₂₀—CH₃; and L-farnesyl, where farnesol is 3,7,11-trimethyldodeca-2,6,10-trien-1-ol.

It is possible to utilize mixtures of the various types of co-curing functionalities described hereinabove.

### Polymer Backbone

As used through this specification, the term “polymer backbone” is intended to have a broad meaning and encompasses homopolymers, copolymers, terpolymers, etc. which are derived from the polymerization of at least one olefin monomer. The polymer backbone to which co-curing functionality is attached is not particularly restricted, and the selection of a suitable polymer is within the purview of a person skilled in the art.

As used throughout this specification, the term “olefin monomer” is intended to have a broad meaning and encompasses α-olefin monomers, diolefin monomers and polymerizable monomers containing at least one olefin linkage. In a preferred embodiment, the olefin monomer is an α-olefin monomer. α-Olefin monomers are well known in the art and the choice thereof for use in the present process is within the purview of a person skilled in the art. In some embodiments, the α-olefin monomer is isobutylene, propylene, 1-butene, 1-pentene, 1-hexene, 1-octene, branched isomers thereof, styrene, α-methylstyrene, para-methylstyrene or mixtures thereof. In certain embodiments, α-olefin monomers are isobutylene and para-methylstyrene.

In yet another embodiment, the olefin monomer comprises a diolefin monomer. Diolefin monomers are well known in the art and the choice thereof for use in the present process is within the purview of a person skilled in the art. In one embodiment, the diolefin monomer is an aliphatic compound. Non limiting examples of suitable aliphatic compounds include 1,3-butadiene, isoprene, 2,3-dimethyl-1,3-butadiene, 2-ethyl-1,3-butadiene, piperylene, myrcene, allene, 1,2-butadiene, 1,4,9-decatriene, 1,4-hexadiene, 1,6-octadiene, 1,5-hexadiene, 4-methyl-1,4-hexadiene, 5-methyl-1,4-hexadiene, 7-methyl-1,6-octadiene, phenylbutadiene, pentadiene or mixtures thereof. In another embodiment, the diolefin monomer is an alicyclic compound. Non-limiting examples of suitable alicyclic compounds include norbornadiene, aliphatic derivatives thereof, 5-alkylidene-2-norbornene compounds, 5-alkenyl-2-norbornene compounds and mixtures thereof, such as 5-methylene-2-norbornene, 5-ethylidene-2-norbornene, 5-propenyl-2-norbornene or mixtures thereof. Further non-limiting examples of suitable alicyclic compounds include 1,4-cyclohexadiene, 1,5-cyclooctadiene, 1,5-cyclododecadiene, methyltetrahydroindene, dicyclopentadiene, bicyclo[2.2.1]hepta-2,5-diene or mixtures thereof. In certain embodiments, the diolefin monomer is isoprene.

It is possible to utilize mixtures of the various types of olefin monomers described hereinabove.

In an embodiment, the olefin is a mixture of isobutylene and at least one diolefin monomer (as described hereinabove). In some embodiments, such monomer mixture comprises isobutylene and isoprene wherein about 0.5 to about 3 mole percent of the diolefin monomer is incorporated into the mixture. In certain embodiments, from about 1 to about 2 mole percent of the diolefin monomer is incorporated into the mixture.

In other embodiments, the olefin is a mixture of isobutylene and at least one α-olefin (as described hereinabove). In some embodiments, such monomer mixture comprises isobutylene and para-methylstyrene wherein about 0.5 to about 3 mole percent of the α-olefin monomer is incorporated into the mixture. In certain embodiments, from about 1 to about 2 mole percent of the α-olefin monomer is incorporated into the isobutylene and para-methylstyrene mixture.

In some embodiments, the polymer backbone used in the present invention has a number-average molecular weight (Mn) in the range from about 10,000 to about 500,000. In certain embodiments, Mn is from about 10,000 to about 200,000. In certain other embodiments, Mn is from about 60,000 to about 150,000. In still other embodiments, Mn is from about 30,000 to about 100,000. It will be understood by those of skill in the art that reference to molecular weight refers to a population of polymer molecules and not necessarily to a single or particular polymer molecule.

### Filler

In some embodiments, a co-curing polymer contains one or more fillers such as carbon black, precipitated silica, clay, glass fibres, polymeric fibres and finely divided minerals. These additives are typically used to improve the physical properties of polymers, including abrasion resistance, stiffness and UV resistance. Typically, the amount of filler is between about 10 wt % and about 60 wt %. In some embodiments, filler content is between about 25 wt % and about 45 wt %.

In other embodiments, a co-curing polymer formulation contains one or more nano-scale fillers such as exfoliated clay platelets, sub-micron particles of carbon black, and sub-micron particles of mineral fillers such as silica. These nano-scale additives are typically used to improve the physical properties of polymers, including impermeability and stiffness. Typically, the amount of nano-scale filler is between about 0.5 wt % and about 30 wt %. In certain embodiments, nano-scale filler content is between about 2 wt % and about 10 wt %.

### Preparation of Co-Curing Polymer

An aspect of the present invention provides a method of preparing a co-curing polymer from a halogenated elastomer and a nucleophile that contains co-curing functionality. In an embodiment, the halogenated elastomer is BIIR, CIIR, BIMS or polychloroprene.

In an embodiment, co-curing functionality is introduced to an isobutylene-rich polymer backbone by reaction of a halogenated elastomer and a carboxylate nucleophile. These reactions can be conducted under solvent-free conditions, or using a solvent that dissolves the halogenated elastomer. A non-limiting example is the reaction of BIIR with (Bu₄N⁺)(CH₂═CH—(CH₂)₈COO⁻) as illustrated below. As those with skill in the art of the invention will recognize, the co-curing polymer generated by this process has a polymer backbone comprising isobutylene and isoprene mers, multiple co-curing functional groups comprising an eight-carbon alkyl chain with a terminal olefin unit that are attached to the polymer backbone by a covalent link comprising an ester moiety.

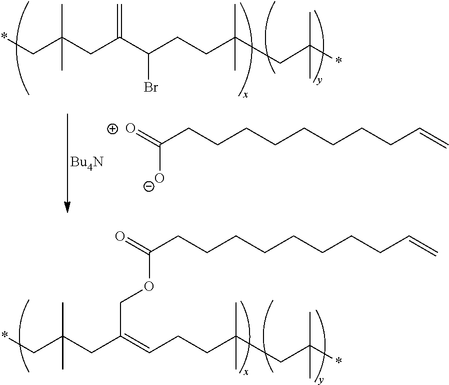

Another non-limiting example is the reaction of BIMS with a carboxylate-terminated poly(ethylene oxide) moiety as illustrated below. As those with skill in the art of the invention will recognize, the co-curing polymer generated by this process has a polymer backbone made up of isobutylene and para-methylstyrene mers, multiple co-curing functionality groups comprising a methyl-terminated oligomeric ether that are attached to the polymer backbone by a covalent link comprising a succinate diester moiety.

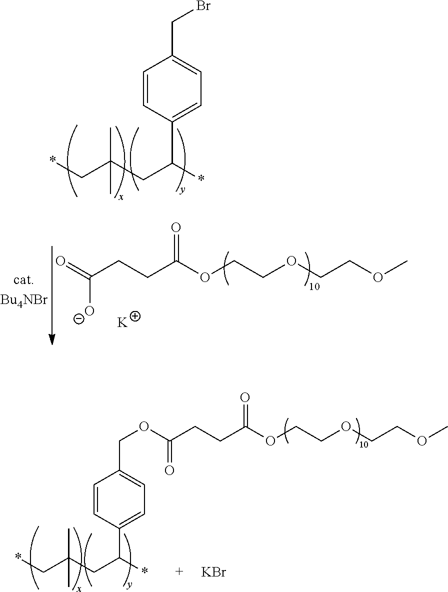

### Cross-Linking Co-Curing Polymers

In one aspect, the invention provides a method of preparing a cross-linked polymer article, comprising the steps of: (i) mixing a co-curing polymer and a co-agent, and (ii) subjecting the mixture to a radical generating technique.

The process for cross-linking a co-curing polymer formulation requires the use of a radical generating technique. Free-radicals may, for example, be generated through the use of ultraviolet light, a chemical initiator (such as a peroxide), thermo-mechanical means, radiation, electron bombardment or the like. See any of the following references for a general discussion on radical generation techniques: Moad, G. Prog. Polym. Sci. 1999, 24, 81-142; Russell, K. E. Prog. Polym. Sci. 2002, 27, 1007-1038; and Lazar, M., Adv. Polym. Sci. 1989, 5, 149-223.

When an organic peroxide is used, the organic peroxide is generally present in an amount between about 0.005 wt % and about 5.0 wt %. In some embodiments, it is present in an amount between about 0.05 wt % and about 1.0 wt %.

In embodiments of the invention, the co-agent contains two or more maleimide groups. Non-limiting examples include N,N′-m-phenylenedimaleimide or N,N′-hexamethylenedimaleimide, whose structures are illustrated below.

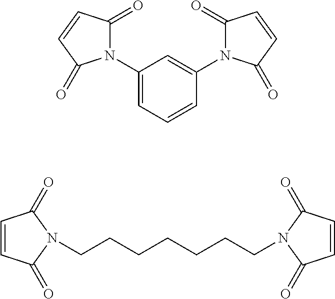

Other non-limiting examples of co-agents include maleimide, bis-maleimide, tris-maleimide, trimethylolpropane triacrylate, or diallylisophthalate. It is possible to use a combination of co-agents, including combinations of co-agents described herein.

Since a co-curing polymer is cross-linked through reactions between co-curing functionality and a co-agent, the concentration of co-agent used in the formulation will affect the extent of polymer cross-linking. Typically, the co-agent content of a co-curing polymer formulation is from about 0.1 wt % to about 10 wt %. In some embodiments, the co-agent content is between about 0.5 wt % and about 2 wt %.

### Cured Product

An aspect of the present invention includes a cross-linked product of co-curing polymer described hereinabove. In certain embodiments, the cross-linked product contains an isobutylene-rich polymer backbone with cross-links formed from reaction of co-curing functionality and co-agent. These cross-linked products are expected to have superior qualities such as good thermo-oxidative stability, exceptional compression set resistance, high modulus, and excellent gas impermeability. Accordingly, articles made from such cross-linked polymers, such as, for example, tire inner liners, gaskets, and sealants, can exploit these qualities without the presence of halogen, sulfur and/or metal byproducts, or high levels of extractable initiator byproducts.

Embodiments of the present invention will be described with reference to the following Working Examples, which are provided for illustrative purposes only and should not be used to limit or construe the scope of the invention.

### WORKING EXAMPLES

### Materials and Methods

Poly(isobutylene) was used as received from Scientific Polymer Products (Ontario, N.Y., USA). Brominated poly(isobutylene-co-isoprene) (BIIR) containing 0.15 mmole allylic bromide per gram was used as manufactured by LANXESS Inc. (Sarnia, ON, Canada). Brominated poly(isobutylene-co-methylstyrene) containing 0.21 mmole benzylic bromide per gram was used as manufactured by Exxon Mobil (Houston, Tex., USA). Methoxyethoxy-ethanol (99%) was used as received from TCI America (Portland, Oreg., USA). The following reagents were used as received from Sigma-Aldrich (Oakville, ON, Canada) succinic anhydride (99%), tetrabutylammonium hydroxide (1 M in methanol), tetrabutylammonium bromide (98%), farnesol (95%), 9-decen-1-ol (90%), 10-undecenoic acid (98%), oleic acid (99%), lineloic acid (99%), polyethyleneglycol monomethylether (Mw=750), N,N′-m-phenylenedimaleimide (HVA2, 96%). Precipitated silica (HiSil 233) was used as received from PPG (Pittsburgh, Pa., USA).

¹H NMR spectra were acquired in CDCl3 on a Bruker Avance-400 spectrometer (Bruker, Milton, ON, Canada). The extent of crosslinking as a function of time was monitored through measurements of dynamic shear modulus (G′) using an Alpha Technologies, Advanced Polymer Analyzer 2000 (Akron, Ohio, USA) operating at an oscillation frequency of 1 Hz and an arc of 3°.

### Example 1

### Comparative Example

### Failure of Polyisobutylene to Co-Cure

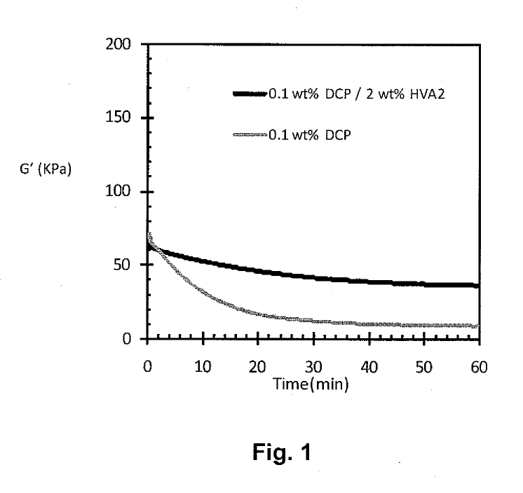

Polyisobutylene (5 g) was coated with a solution of DCP (0.092 mmol, 0.025 g) in acetone (1-5 mL) and allowed to dry before passing the sample 5 times through a 2-roll mill. The rheometry data illustrated in FIG. 1 show that this mixture did not crosslink significantly when heated to 160° C. Polyisobutylene was coated with DCP as described above and mixed with HVA2 (0.1 g, 0.37 mmol) by repeated passing through a 2-roll mill. The rheometry data shown in FIG. 1 show that polyisobutylene, when activated by peroxide in the presence of HVA2, does not cure significantly, thereby establishing that a polyisobutylene backbone is not a co-curing elastomer.

### Example 2

### Synthesis and Co-Curing of IIR-g-Ether

Methoxyethoxyethanol (1.5 g, 12.5 mmol) and succinic anhydride (1.87 g, 18.7 mmol) were dissolved in toluene (10 g) and heated to 80° C. for 4 hr. Residual starting materials and solvent were removed by Kugelrohr distillation (T=80° C., P=0.6 mmHg). The resulting acid-ester (0.72 g, 3.3 mmol) was treated with a 1 M solution of Bu₄NOH in methanol (3.3 mL, 3.3 mmol Bu₄NOH) to yield the desired Bu₄Ncarboxylate salt, which was isolated by removing methanol under vacuum.

BIIR (11 g) and Bu₄NBr (0.53 g, 1.65 mmol) were dissolved in toluene (100 g) and heated to 85° C. for 180 min. The desired Bu₄Ncarboxylate salt (1.52 g, 3.3 mmol) was added before heating the reaction mixture to 85° C. for 60 min. The esterification product was isolated by precipitation from excess acetone, purified by dissolution/precipitation using hexanes/acetone, and dried under vacuum, yielding IIR-g-ether.

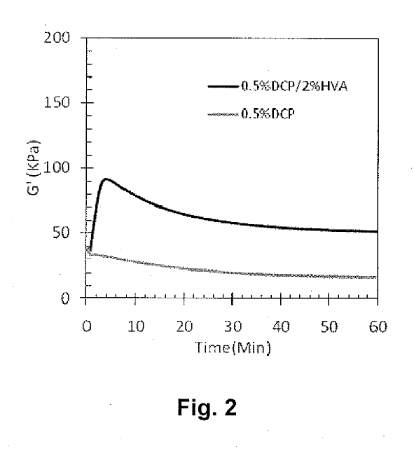

IIR-g-ether (5 g) was coated with a solution of DCP (0.092 mmol, 0.025 g) in acetone (1-5 mL) and allowed to dry before passing the sample 5 times through a 2-roll mill. The rheometry data illustrated in FIG. 2 show that this mixture did not crosslink significantly when heated to 160° C. IIR-g-ether was coated with DCP as described above and mixed with co-agent N,N′-m-phenylenedimaleimide (HVA2) (0.1 g, 0.37 mmol) by repeated passing through a 2-roll mill. The rheometry data shown in FIG. 2 show that IIR-g-ether, when activated by peroxide in the presence of HVA2, cures significantly, thereby establishing IIR-g-ether as a co-curing elastomer.

### Example 3

### Synthesis and Co-Curing of IIR-g-PEG

Polyethyleneglycol monomethylether (19.4 mmol, 14.1 g), and succinic anhydride (23.2 mmol, 2.33 g) were dissolved in toluene (10 g) and heated to 80° C. for 4 hr. Residual starting materials and solvent were removed by Kugelrohr distillation (T=80° C., P=0.6 mmHg). The resulting acid-ester (2.8 g, 3.3 mmol) was treated with a 1 M solution of Bu₄NOH in methanol (3.3 mL, 3.3 mmol Bu₄NOH) to yield the desired Bu₄Ncarboxylate salt, which was isolated by removing methanol under vacuum.

BIIR (11 g) and Bu₄NBr (0.53 g, 1.65 mmol) were dissolved in toluene (100 g) and heated to 85° C. for 180 min. The desired Bu₄Ncarboxylate salt (3.6 g, 3.3 mmol) was added before heating the reaction mixture to 85° C. for 60 min. The esterification product was isolated by precipitation from excess acetone, purified by dissolution/precipitation using hexanes/acetone, and dried under vacuum, yielding IIR-g-PEG.

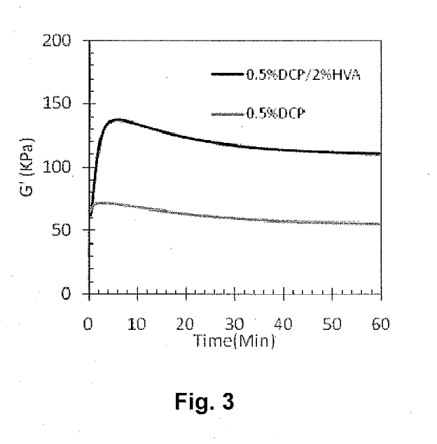

IIR-g-PEG (5 g) was coated with a solution of DCP (0.092 mmol, 0.025 g) in acetone (1-5 mL) and allowed to dry before passing the sample 5 times through a 2-roll mill. The rheometry data illustrated in FIG. 3 show that this mixture did not crosslink significantly when heated to 160° C. IIR-g-PEG was coated with DCP as described above and mixed with HVA2 (0.1 g, 0.37 mmol) by repeated passing through a 2-roll mill. The rheometry data shown in FIG. 3 show that IIR-g-PEG, when activated by peroxide in the presence of HVA2, cures significantly, thereby establishing IIR-g-PEG as a co-curing elastomer.

### Example 4

### Synthesis and Co-Curing of IIR-g-Decenol

9-Decen-1-ol (9.6 mmol, 1.5 g) and succinic anhydride (12 mmol, 1.2 g) were dissolved in toluene (10 g) and heated to 80° C. for 4 hr. Residual starting materials and solvent were removed by Kugelrohr distillation (T=80° C., P=0.6 mmHg). The resulting acid-ester (0.63 g, 2.47 mmol) was treated with a 1 M solution of Bu₄NOH in methanol (2.47 mL, 2.47 mmol Bu₄NOH) to yield the desired Bu₄Ncarboxylate salt, which was isolated by removing methanol under vacuum.

BIIR (11 g) and Bu₄NBr (0.53 g, 1.65 mmol) were dissolved in toluene (100 g) and heated to 85° C. for 180 min. The desired Bu₄Ncarboxylate salt (1.23 g, 2.47 mmol) was added before heating the reaction mixture to 85° C. for 60 min. The esterification product was isolated by precipitation from excess acetone, purified by dissolution/precipitation using hexanes/acetone, and dried under vacuum, yielding IIR-g-decenol.

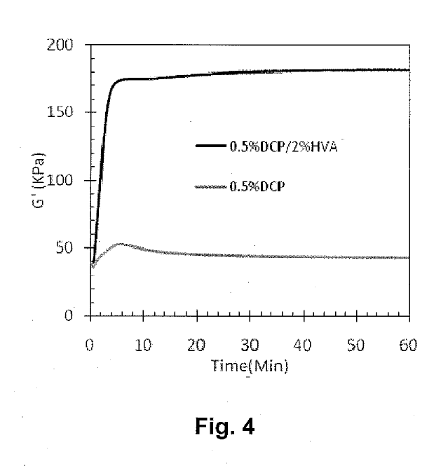

IIR-g-decenol (5 g) was coated with a solution of DCP (0.092 mmol, 0.025 g) in acetone (1-5 mL) and allowed to dry before passing the sample 5 times through a 2-roll mill. The rheometry data illustrated in FIG. 4 show that this mixture did not crosslink significantly when heated to 160° C. IIR-g-decenol was coated with DCP as described above and mixed with HVA2 (0.1 g, 0.37 mmol) by repeated passing through a 2-roll mill. The rheometry data shown in FIG. 4 show that IIR-g-decenol, when activated by peroxide in the presence of HVA2, cures significantly, thereby establishing IIR-g-decenol as a co-curing elastomer.

### Example 5

### Synthesis and Co-Curing of IIR-g-Farnesol

Farnesol (9.0 mmol, 2 g) and succinic anhydride (10 mmol, 1 g) were dissolved in toluene (10 g) and heated to 80° C. for 4 hr. Residual starting materials and solvent were removed by Kugelrohr distillation (T=80° C., P=0.6 mmHg). The resulting acid-ester (1.06 g, 3.3 mmol) was treated with a 1 M solution of Bu₄NOH in methanol (3.3 mL, 3.3 mmol Bu₄NOH) to yield the desired Bu₄Ncarboxylate salt, which was isolated by removing methanol under vacuum.

BIIR (11 g) and Bu₄NBr (0.53 g, 1.65 mmol) were dissolved in toluene (100 g) and heated to 85° C. for 180 min. The desired Bu₄Ncarboxylate salt (1.92 g, 3.3 mmol) was added before heating the reaction mixture to 85° C. for 60 min. The esterification product was isolated by precipitation from excess acetone, purified by dissolution/precipitation using hexanes/acetone, and dried under vacuum, yielding IIR-g-farnesol.

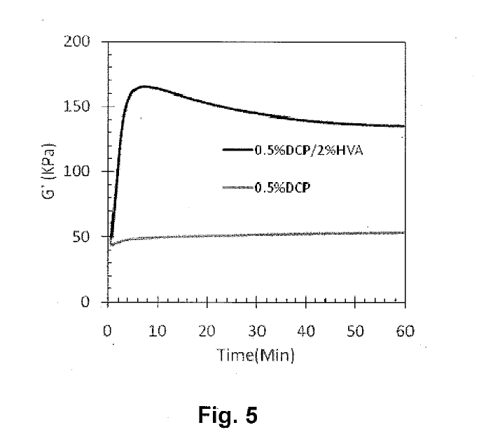

IIR-g-farnesol (5 g) was coated with a solution of DCP (0.092 mmol, 0.025 g) in acetone (1-5 mL) and allowed to dry before passing the sample 5 times through a 2-roll mill. The rheometry data illustrated in FIG. 5 show that this mixture did not crosslink significantly when heated to 160° C. IIR-g-farnesol was coated with DCP as described above and mixed with HVA2 (0.1 g, 0.37 mmol) by repeated passing through a 2-roll mill. The rheometry data shown in FIG. 5 show that IIR-g-farnesol, when activated by peroxide in the presence of HVA2, cures significantly, thereby establishing IIR-g-farnesol as a co-curing elastomer.

### Example 6

### Synthesis and Co-Curing of IIR-g-Oleate

Oleic Acid (0.93 g, 3.3 mmol) was treated with a 1 M solution of Bu₄NOH in methanol (3.3 mL, 3.3 mmol Bu₄NOH) to yield the desired Bu₄Ncarboxylate salt, which was isolated by removing methanol under vacuum

BIIR (16 g) and Bu₄NBr (0.77 g, 2.4 mmol) were dissolved in toluene (160 g) and heated to 85° C. for 180 min. The desired Bu₄Ncarboxylate salt (1.72 g, 3.3 mmol) was added before heating the reaction mixture to 85° C. for 60 min. The esterification product was isolated by precipitation from excess acetone, purified by dissolution/precipitation using hexanes/acetone, and dried under vacuum, yielding IIR-g-oleate.

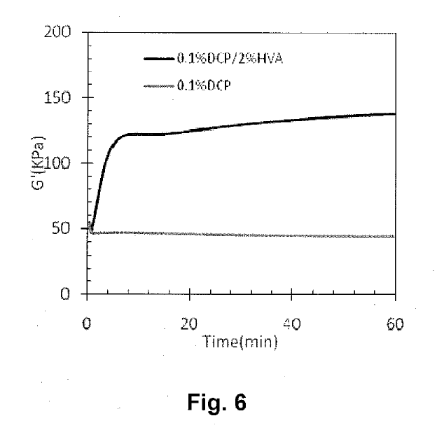

IIR-g-oleate acid (5 g) was coated with a solution of DCP (0.092 mmol, 0.025 g) in acetone (1-5 mL) and allowed to dry before passing the sample 5 times through a 2-roll mill. The rheometry data illustrated in FIG. 6 show that this mixture did not crosslink significantly when heated to 160° C. IIR-g-oleate was coated with DCP as described above and mixed with HVA2 (0.1 g, 0.37 mmol) by repeated passing through a 2-roll mill. The rheometry data shown in FIG. 6 show that IIR-g-oleic acid, when activated by peroxide in the presence of HVA2, cures significantly, thereby establishing IIR-g-oleate as a co-curing elastomer.

### Example 7

### Synthesis and Co-Curing of IIR-g-Lineolate

BIIR (16 g), lineloic acid (0.74 g, 2.6 mmol), KOH (0.71 g, 12 mmol) and Bu₄NBr (0.22 g, 0.69 mmol) were dissolved in toluene (160 g) and heated to 85° C. for 300 min. The esterification product was isolated by precipitation from excess acetone, purified by dissolution/precipitation using hexanes/acetone, and dried under vacuum, yielding IIR-g-lineolate.

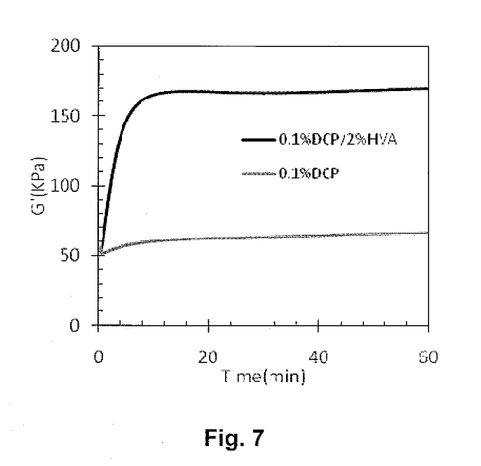

IIR-g-lineolate (5 g) was coated with a solution of DCP (0.092 mmol, 0.025 g) in acetone (1-5 mL) and allowed to dry before passing the sample 5 times through a 2-roll mill. The rheometry data illustrated in FIG. 7 show that this mixture did not crosslink significantly when heated to 160° C. IIR-g-lineolate was coated with DCP as described above and mixed with HVA2 (0.1 g, 0.37 mmol) by repeated passing through a 2-roll mill. The rheometry data shown in FIG. 7 show that IIR-g-linoleate, when activated by peroxide in the presence of HVA2, cures significantly, thereby establishing IIR-g-linoleate as a co-curing elastomer.

### Example 8

### Synthesis and Co-Curing of IIR-g-Undecenoate

BIIR (16 g), 10-undecenoic acid (0.49 g, 2.6 mmol), KOH (0.71 g, 12 mmol) and Bu₄NBr (0.22 g, 0.69 mmol) were dissolved in toluene (160 g) and heated to 85° C. for 300 min. The esterification product was isolated by precipitation from excess acetone, purified by dissolution/precipitation using hexanes/acetone, and dried under vacuum, yielding IIR-g-undecenoate acid.

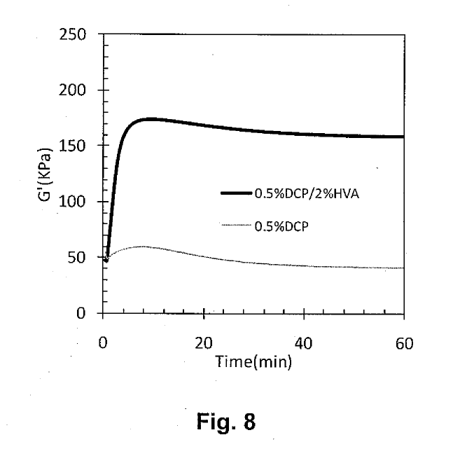

IIR-g-undecenoate (5 g) was coated with a solution of DCP (0.092 mmol, 0.025 g) in acetone (1-5 mL) and allowed to dry before passing the sample 5 times through a 2-roll mill. The rheometry data illustrated in FIG. 8 show that this mixture did not crosslink significantly when heated to 160° C. IIR-g-undecenoate was coated with DCP as described above and mixed with HVA2 (0.1 g, 0.37 mmol) by repeated passing through a 2-roll mill. The rheometry data shown in FIG. 8 show that IIR-g-undecenoate, when activated by peroxide in the presence of HVA2, cures significantly, thereby establishing IIR-g-undecenoate as a co-curing elastomer.

It will be understood by those skilled in the art that this description is made with reference to certain embodiments and that it is possible to make other embodiments employing the principles of the invention which fall within its spirit and scope as defined by the claims.

1. A polymer comprising:
a polymeric main chain that comprises polymerized olefin monomers, isobutylene-co-isoprene, or isobutylene-co-methylstyrene; and
a plurality of side chains comprising a co-curing functionality which is an ether, a terminal olefin, or an internal olefin;
wherein the polymer forms crosslinks when subjected to a free-radical initiator only in the presence of a co-agent.

2. A method of making the polymer of claim 1 comprising:
reacting halogenated polymer with a nucleophile that comprises a co-curing functionality, wherein the nucleophile replaces the halide of the halogenated polymer.

3. The method of claim 2, wherein the nucleophile that comprises a co-curing functionality further comprises a carboxylate group.

4. The method of claim 2, wherein the halogenated polymer is BIIR, CIIR, BIMS, or polychloroprene.

5. A crosslinked polymer prepared by subjecting the polymer of claim 1 to a free-radical initiator in the presence of a co-agent.

6. (canceled)

7. A method of crosslinking the polymer of claim 1, comprising:
mixing the polymer with a co-agent to form a mixture;
subjecting the mixture to a free-radical initiator; and
allowing reactions to occur such that crosslinking-bonds form and cured product is obtained.

8.-9. (canceled)

10. The polymer of claim 1, wherein the α-agent comprises at least two maleimide moieties.

11. The polymer of claim 1, wherein the co-agent comprises maleimide, bis-maleimide, tris-maleimide, trimethylolpropane triacrylate, diallylisophthalate, N,N′-m-phenylenedimaleimide, N,N′-hexamethylenedimaleimide, or a combination thereof.

12. The polymer of claim 1, wherein the free-radical initiator is: a chemical free-radical initiator, a photoinitiator, heat, heat in the presence of oxygen, electron bombardment, irradiation, high-shear mixing, photolysis (photo-initiation), electron beam radiation, or radiation bombardment.

13. The polymer of claim 12, wherein the chemical free-radical initiator is an organic peroxide, a hydroperoxide, bicumene, dicumyl peroxide, di-t-butyl peroxide, an azo-based initiator, or homolysis of an organic peroxide.

14. (canceled)

15. The method of claim 2, wherein the co-agent comprises at least two maleimide moieties.

16. The crosslinked polymer of claim 5, wherein the co-agent comprises at least two maleimide moieties.

17. The method of claim 2, wherein the co-agent comprises maleimide, bis-maleimide, tris-maleimide, trimethylolpropane triacrylate, diallylisophthalate, N,N′-m-phenylenedimaleimide, N,N′-hexamethylenedimaleimide, or a combination thereof.

18. The crosslinked polymer of claim 5, wherein the co-agent comprises maleimide, bis-maleimide, tris-maleimide, trimethylolpropane triacrylate, diallylisophthalate, N,N′-m-phenylenedimaleimide, N,N′-hexamethylenedimaleimide, or a combination thereof.

19. The method of claim 2, wherein the free-radical initiator is: a chemical free-radical initiator, a photoinitiator, heat, heat in the presence of oxygen, electron bombardment, irradiation, high-shear mixing, photolysis (photo-initiation), electron beam radiation, or radiation bombardment.

20. The crosslinked polymer of claim 5, wherein the free-radical initiator is: a chemical free-radical initiator, a photoinitiator, heat, heat in the presence of oxygen, electron bombardment, irradiation, high-shear mixing, photolysis (photo-initiation), electron beam radiation, or radiation bombardment.

21. The crosslinked polymer of claim 20, wherein the chemical free-radical initiator is an organic peroxide, a hydroperoxide, bicumene, dicumyl peroxide, di-t-butyl peroxide, an azo-based initiator, or homolysis of an organic peroxide.
